(19) United States
(12) Patent Application Publication
(10) Pub. No.: US 2014/0301802 A1
(43) Pub. Date: Oct. 9, 2014

(54) Zero-Backlash Bushing

(71) Applicant: Eugeniusz Kozak, Mount Olive, NJ (US)

(72) Inventor: Eugeniusz Kozak, Mount Olive, NJ (US)

(21) Appl. No.: 13/857,239

(22) Filed: Apr. 5, 2013

(51) Int. Cl. F16B 29/00

(52) U.S. Cl. CPC F16B 29/00
USPC 411/55

(57) ABSTRACT

A zero-backlash bushing employs a dual-component composite design, comprising a tapered resilient slotted bushing core compressibly engaged by a cylindrical annular sleeve. As opposed to the axial pressure of a locking nut, the annular sleeve exerts a circumferential pressure on the bushing core, thereby inducing a tight radial engagement between the threads of the bushing core and the adjustment screw, as opposed to the lateral thread engagement induced by a locking nut. This tight radial engagement leaves radial gaps between the threads of the bushing core and the screw, which radial gaps can be filled with grease. Slots in the bushing core enable migration of grease within the bushing and facilitate constriction of the bushing core.

### BACKGROUND OF THE INVENTION

The present invention relates to field of bushing assemblies that are matched with fine and ultra-fine adjustment screws of the type used in the alignment of optical components, such as mirror mounts and lasers. More particularly, the present invention relates to bushing assemblies that reduce or eliminate backlash.

Backlash is a phenomenon that occurs when mechanical components are subjected to pressure and/or vibration, causing them to deviate from their proper positions and/or alignments.

In the case of bushings used in conjunction with fine/ultra-fine adjustment screws for the alignment of optical components, such as lasers, a locking nut is often used to secure the position of the bushing against misalignment. As illustrated in FIGS. 1A and 1B, the tightened locking nut applies an axial pressure to the bushing which forces its threads into a tight lateral engagement with those of the adjustment screw. Nonetheless, the forward-biased thread engagement induced by the locking nut leaves rearward lateral gaps between the engaged threads, which lateral gaps can enable rearward backlash movement of the screw when it is subjected to a load. In order to minimize such backlash, grease is typically applied between the screw and the bushing in order to fill the gaps between their respective threads. But the rearward pressure of the loaded screw will, over time, force the grease to flow out of the lateral inter-thread gaps and through the front of the bushing, thereby exposing the bushing-screw assembly to backlash.

### SUMMARY OF THE INVENTION

The present invention addresses this problem by using a dual-component composite bushing, comprising a tapered resilient slotted bushing core compressibly engaged by a cylindrical annular sleeve. As opposed to the axial pressure of a locking nut, the annular sleeve exerts a circumferential pressure on the bushing core, thereby inducing a tight radial engagement between the threads of the bushing core and the adjustment screw, as opposed to the lateral thread engagement induced by a locking nut. This tight radial engagement leaves radial gaps between the threads of the bushing core and the screw, which radial gaps can be filled with grease.

To prevent the lateral migration of the grease out of the bushing, the present invention uses two design features. First, a central section of the internal threading of the bushing core comprises truncated V-threads which, when threaded into the sharp external V-threads of the screw, isolate the radial gaps as circumferential channels within which the flow of the grease is constrained, thereby preventing its lateral migration out of the bushing. Second, the radial pressure on the grease is relieved by providing oblong longitudinal slots in the central section of bushing core, so that the grease can migrate between the inner circumferential channels, formed between the internal truncated V-threads of the bushing core and the external sharp V-threads of the adjustment screw, and outer circumferential channels, formed between the bushing core and the annular sleeve. Since the grease overflow through the slots is retained within the outer circumferential channels of the composite bushing, upon the relief of the axial pressure by loosening the annular sleeve, this grease flows back through the slots into the inner circumferential channels, thereby ensuring that the inter-thread gaps between the bushing core and the screw remain filled with grease so as to prevent backlash.

The axial compression of the bushing core against the adjustment screw is increased by the tightness of the engagement between the external threading of the bushing core and the internal threading of the annular sleeve. This tightness is maximized in the present invention by two other design features. First, the axial bore of the annular sleeve is tapered to conform inversely to the taper of the shaft of the bushing core, so that the progressive tightening of the sleeve on the core acts to further wedge the external core threading into the internal sleeve threading and increase the axial constriction of the core around the screw. Second, the surface of the annular distal end of the sleeve is impressed with multiple keyway depressions, which can be engaged cooperatively by the congruous key projections of a miniature crescent wrench. The torque of the mini-wrench is used to advance the threading of the sleeve further into the core threading, thereby tightening the inter-thread engagement and increasing the axial compression of the bushing core against the adjustment screw.

In applications where it is desirable to lock the bushing sleeve in place in its fully tightened position, a compressible O-ring is provided in a first annular groove located in an external untapered section at the top of the bushing core shaft. A cooperating second annular groove is provided in a corresponding congruous internal untapered section at the top of the bushing sleeve. When the bushing sleeve is being tightened on the bushing core, the internal untapered section of the bushing sleeve initially engages the O-ring, causing it to contract within the first annular groove. When the bushing sleeve is fully tightened, the second annular groove of the bushing sleeve becomes aligned with the first annular groove of the bushing core, such that the O-ring expands into the second annular groove of the bushing sleeve, thereby locking the bushing sleeve in place. Not only does this O-ring feature prevent the bushing sleeve from loosening, it also prevents the bushing sleeve from being over-tightened so as to strip the conjugate threading between the bushing sleeve and the bushing core.

The foregoing summarizes the general design features of the present invention. In the following sections, specific embodiments of the present invention will be described in some detail. These specific embodiments are intended to demonstrate the feasibility of implementing the present invention in accordance with the general design features discussed above. Therefore, the detailed descriptions of these embodiments are offered for illustrative and exemplary purposes only, and they are not intended to limit the scope either of the foregoing summary description or of the claims which follow.

### BRIEF DESCRIPTION OF THE DRAWINGS

FIG. 1A is a perspective view of a conventional locking nut used to secure the position of a bushing on an adjustment screw;

FIG. 1B is a side profile view of a conventional locking nut used to secure the position of a bushing on an adjustment screw;

FIG. 2 is an isometric view of a composite bushing in accordance with the preferred embodiments of the present invention;

FIG. 3 is a side profile view of a composite bushing in accordance with the first preferred embodiment of the present invention;

FIG. 4 is a top plan view of a composite bushing in accordance with the preferred embodiments of the present invention;

FIG. 5A is a cross-sectional view of the composite bushing of FIG. 4, taken along the section D-D, in accordance with the first preferred embodiment of the present invention;

FIG. 5B is a cross-sectional view of the composite bushing of FIG. 4, taken along the section D-D, in accordance with the second preferred embodiment of the present invention;

FIG. 6 is an isometric view of a bushing core in accordance with the first preferred embodiment of the present invention;

FIG. 7A is a side profile view of a bushing core in accordance with the first preferred embodiment of the present invention;

FIG. 7B is a side profile view of a bushing core in accordance with the second preferred embodiment of the present invention;

FIG. 8A is a side profile view of an adjustment screw;

FIG. 8B is a detail view of the engagement of the external threading of an adjustment screw with the internal threading of the bushing core of the preferred embodiments of the present invention;

FIG. 9 is an isometric view of a bushing sleeve in accordance with the first preferred embodiment of the present invention;

FIG. 10 is a side profile view of a bushing sleeve in accordance with the preferred embodiments of the present invention;

FIG. 11A is a cross-sectional view of the bushing sleeve of FIG. 10, taken along the section A-A, in accordance with the first preferred embodiment of the present invention;

FIG. 11B is a cross-sectional view of the bushing sleeve of FIG. 10, taken along the section A-A, in accordance with the second preferred embodiment of the present invention;

FIG. 12 is a rear perspective view of a bushing sleeve in accordance with the preferred embodiments of the present invention;

FIG. 13 is a rear plan view of a bushing sleeve in accordance with the preferred embodiments of the present invention;

FIG. 14A is a front elevation view of a miniature crescent wrench with key projections in accordance with the preferred embodiments of the present invention;

FIG. 14B is a side profile view of a miniature crescent wrench with key projections in accordance with the preferred embodiments of the present invention;

FIG. 14C is a detail partial front view of a miniature crescent wrench with key projections in accordance with the preferred embodiments of the present invention; and

FIG. 14D is a detail partial side view of a miniature crescent wrench with key projections in accordance with the preferred embodiments of the present invention.

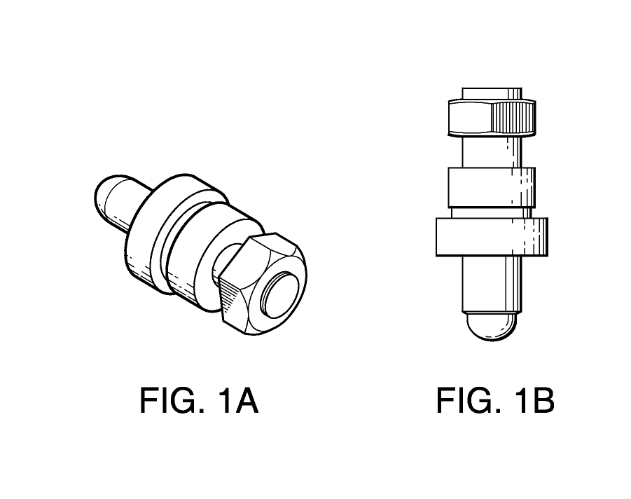

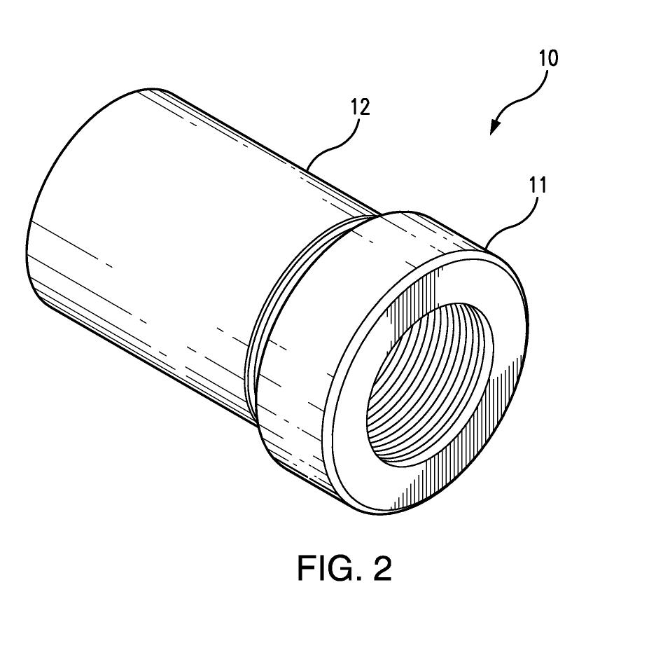

### DETAILED DESCRIPTION OF THE PREFERRED EMBODIMENTS

The present invention has two preferred embodiments. The second preferred embodiment differs from the first preferred embodiment insofar as the second includes the locking O-ring feature.

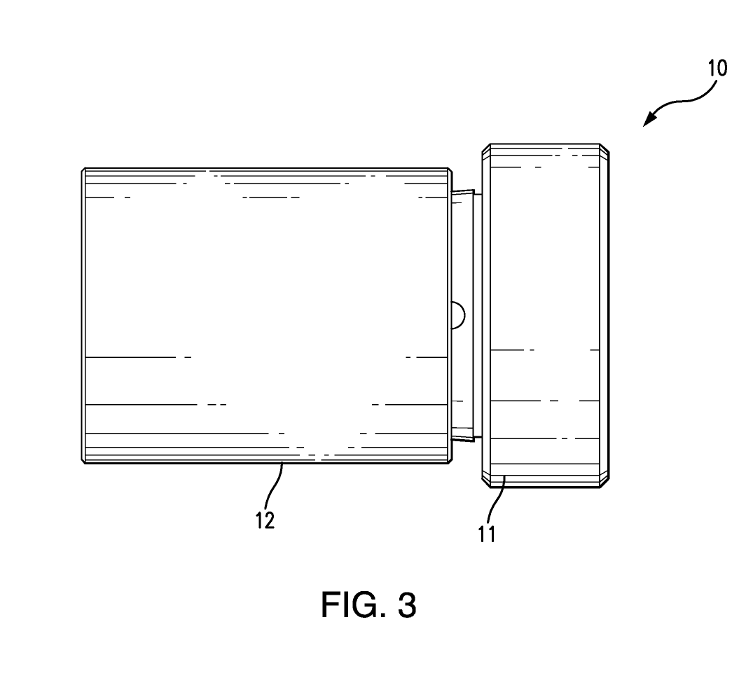

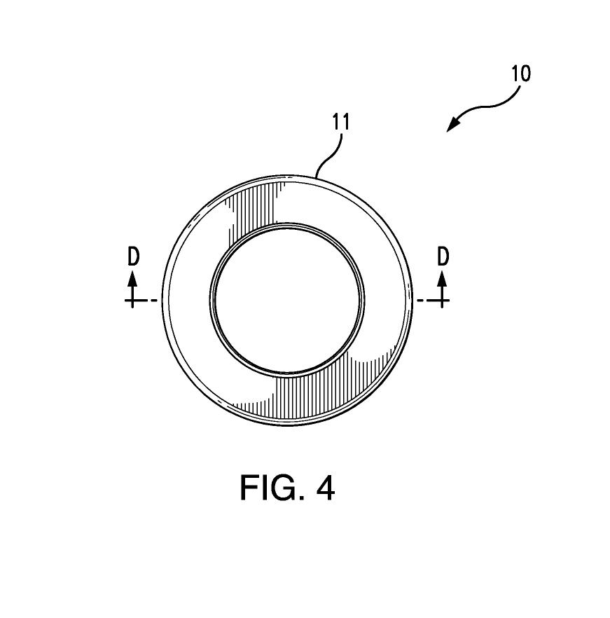

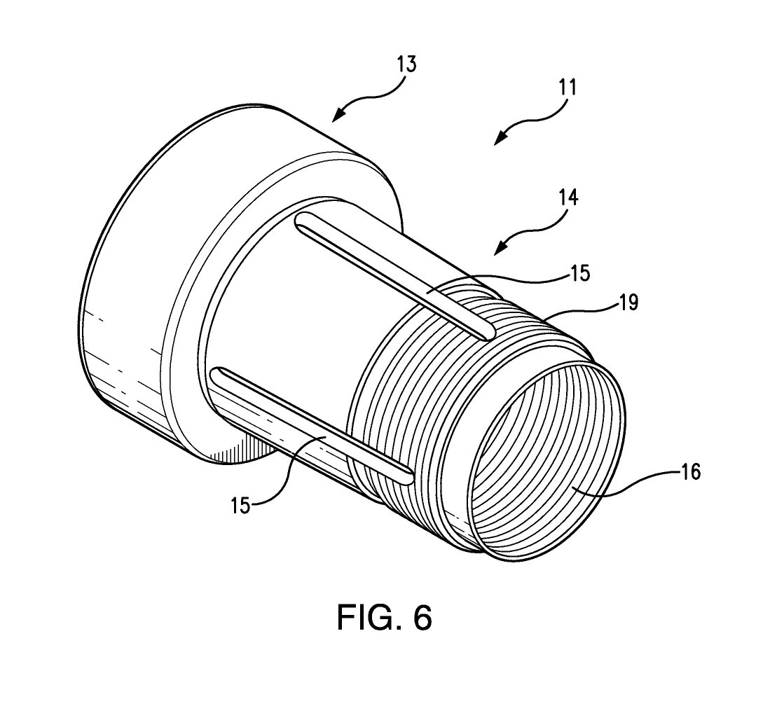

Referring to FIGS. 2-4, a composite bushing 10 according to the preferred embodiments of the present invention comprises bushing core 11 and a bushing sleeve 12. As shown in FIG. 6, the core bushing 11 has a broad annular head section 13 and a narrower tapered shaft 14. While the head section 13 of the bushing core 11 is rigid, the shaft 14 is flexibly resilient, so that its circumference constricts when subjected to sufficient radial pressure and expands again to its original form upon the release of such pressure. The constriction and expansion of the bushing core 11 is facilitated by three longitudinally-oriented oblong core slots 15 in the core's shaft 14.

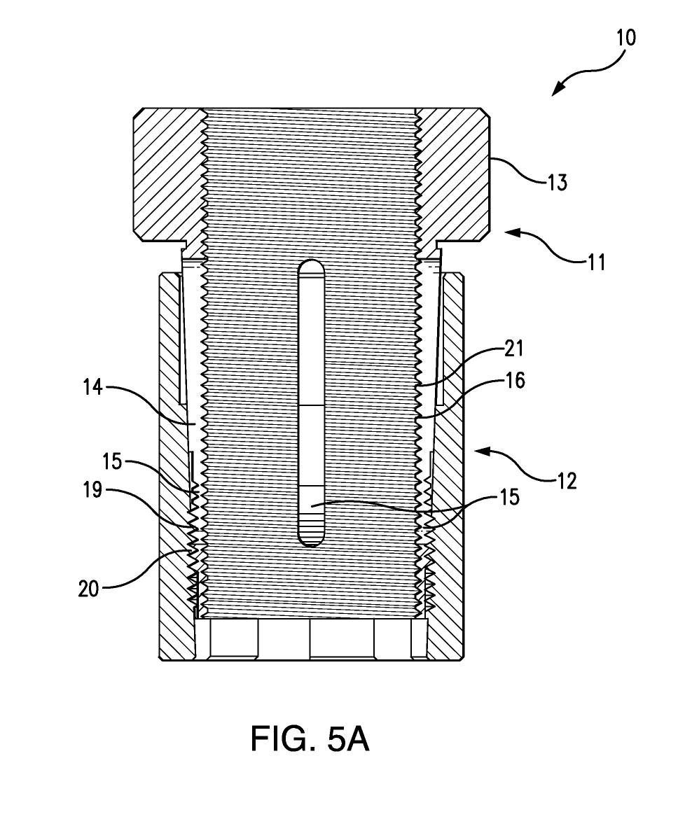

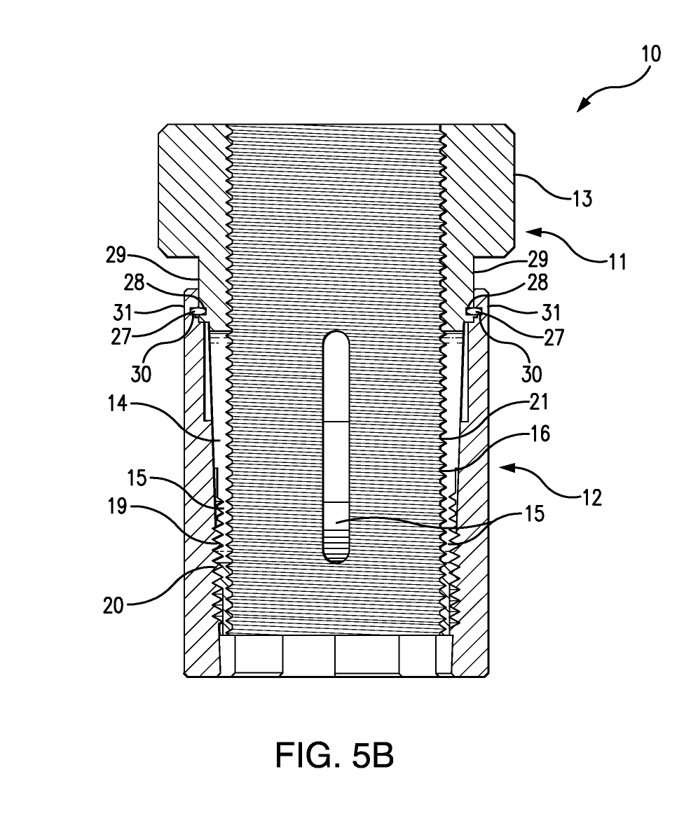

As depicted in FIGS. 5A-B, 7A-B and 8A-B, the bushing core 11 has, along the entire length of its axial bore, core internal threading 16, which is configured to engage the conjugate screw external threading 17 of an adjustment screw 18. On the lower part of its shaft 14, the bushing core 11 has core external threading 19, which is configured to engage the conjugate sleeve internal threading 20 of the bushing sleeve 12. Along the length of the core slots 15, the core internal threading 16 comprises truncated V-threads 21. As explained earlier, the tight radial engagement of the bushing sleeve 12 on the shaft 14 of the bushing core 11 creates radial gaps 32 between the core internal threading 16 and the screw external threading 17, which radial gaps 32 are filled with grease. When the truncated V-threads 21 of the core internal threading 16 are threaded into the sharp V-threads 22 of the screw external threading 17, the greased-filled radial gaps 32 between the conjugate threads are isolated as circumferential channels, within which the flow of grease is constrained and blocked from lateral migration out of the composite bushing 10.

Besides facilitating the radial constriction of the shaft 14 of the bushing core 11, the core slots 15 serve to relieve the outward pressure of the constrained grease flow by enabling the radial migration of the grease from the interior of the bushing core 11 into the interior of the bushing sleeve 12. Since the grease overflow through the core slots 15 is thus retained within the interior of the bushing sleeve 12, when the bushing sleeve 12 is loosened so as to relieve the axial pressure on the shaft 14 of the bushing core 11, this overflow grease flows back through the core slots 15 into the interior of the bushing core 11. This allows the radial gaps between the core internal threading 16 and the screw external threading 17 to remain filled with grease, so as to prevent backlash.

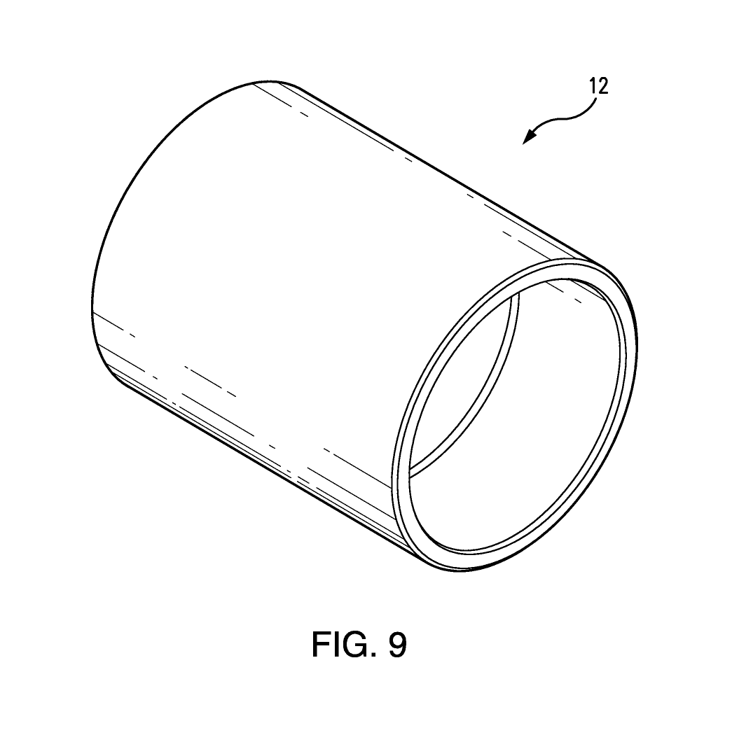

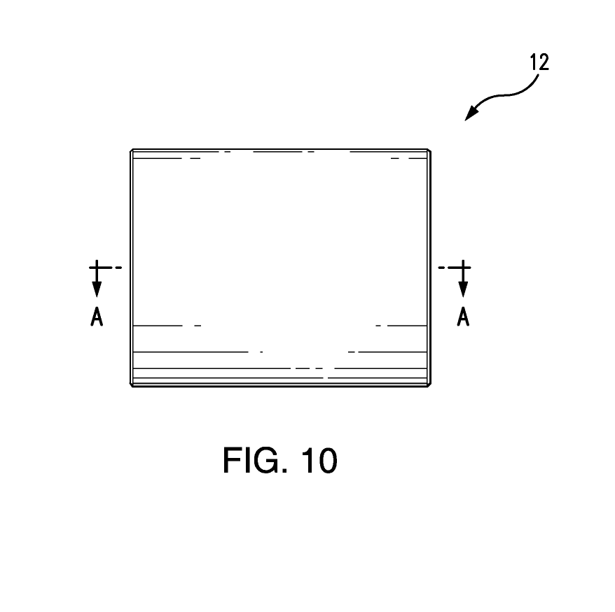

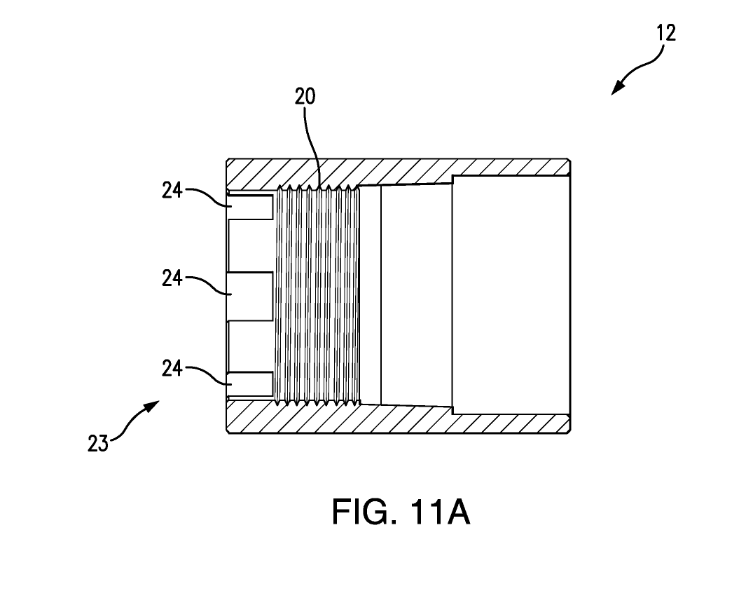

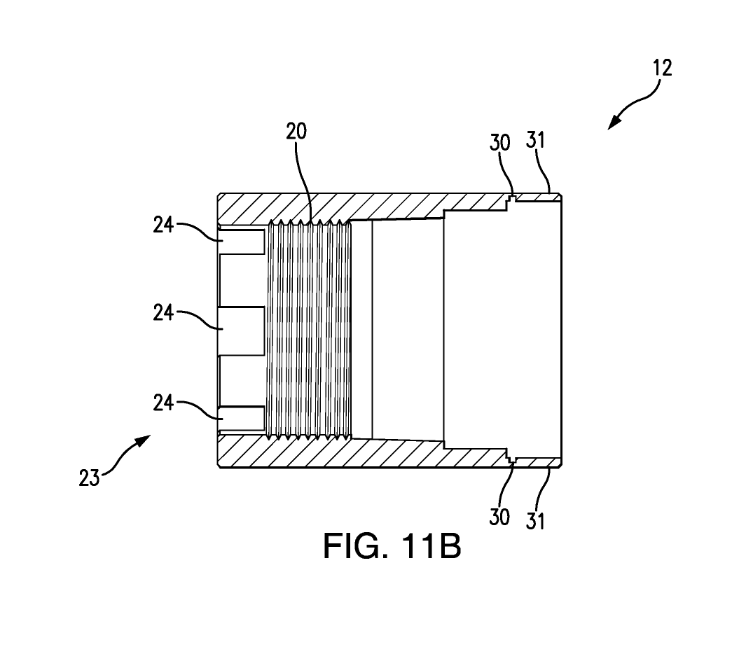

Referring to FIGS. 9-13, the bushing sleeve 12 has an external form which is cylindrical and an internal bore which is tapered to conform inversely to the taper of the shaft 14 of the bushing core 11, so that the progressive tightening of the bushing sleeve 12 on the bushing core 11 acts to further wedge the core external threading 19 into the sleeve internal threading 20, thereby increasing the axial constriction of the bushing core 11 around the adjustment screw 18.

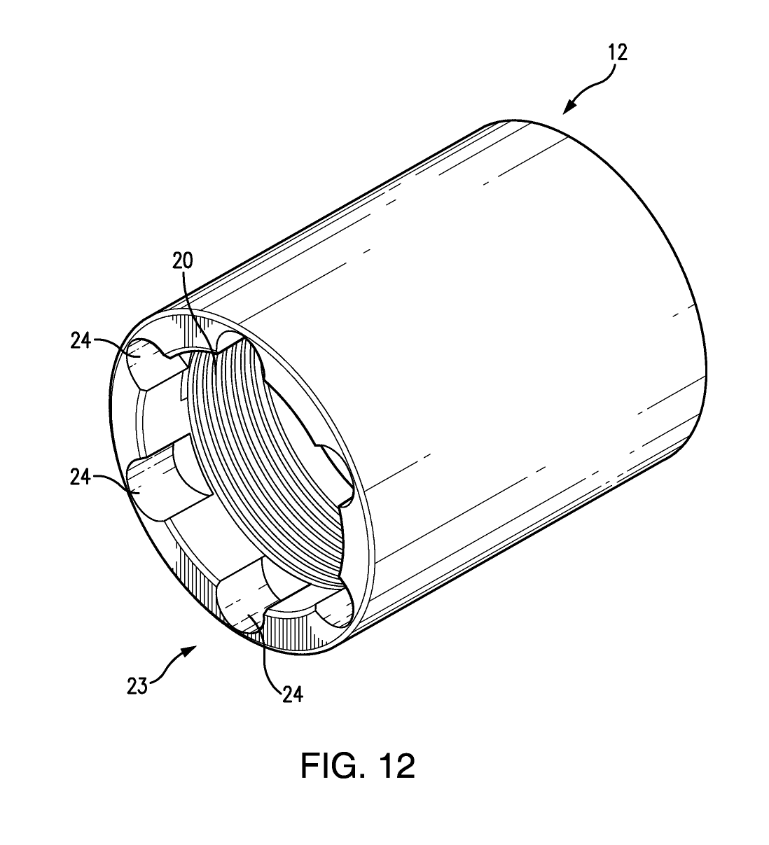

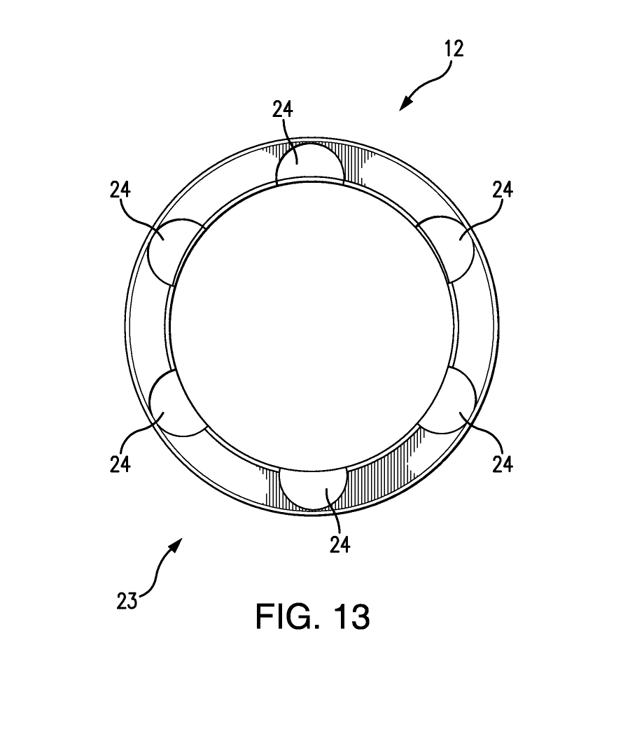

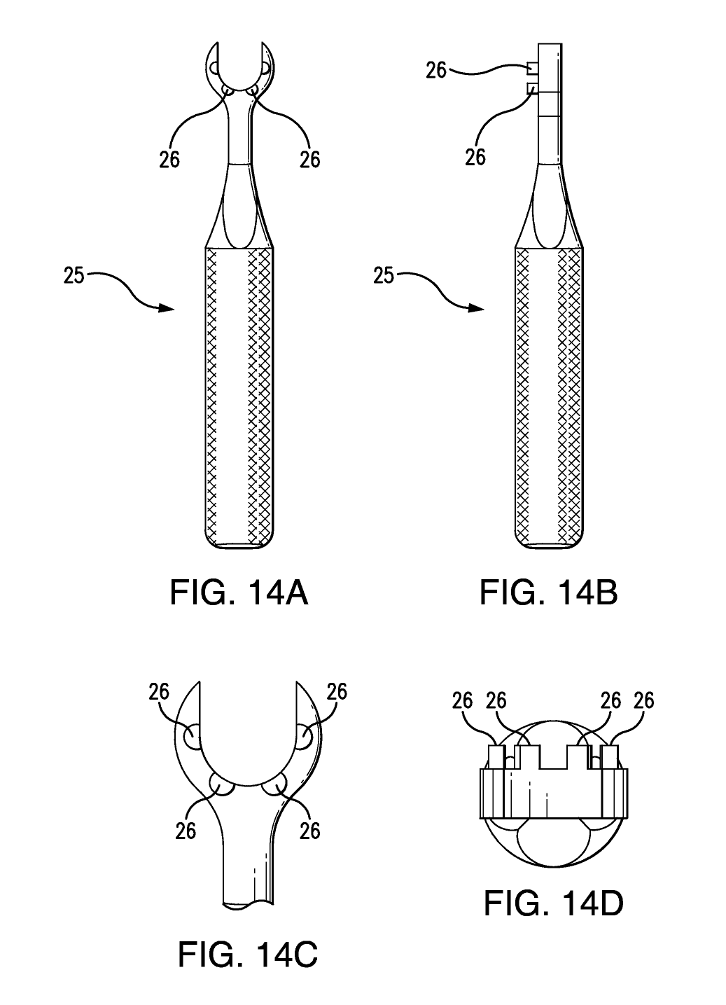

As shown in FIGS. 12 and 13, the surface of the annular distal end 23 of the bushing sleeve 12 is impressed with multiple keyway depressions 24, which can be engaged cooperatively by the congruous key projections 26 of a miniature crescent wrench 25, which is depicted in FIGS. 14A-14D. The torque of the mini-wrench 25 is used to advance the sleeve internal threading 20 further into the core external threading 19, thereby tightening the inter-thread engagement and increasing the axial compression of the bushing core 11 against the adjustment screw 18.

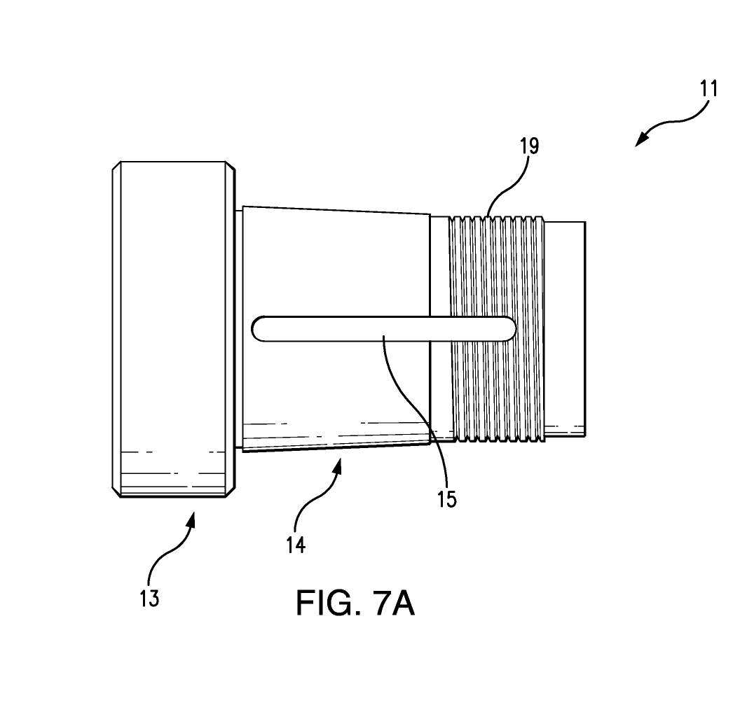

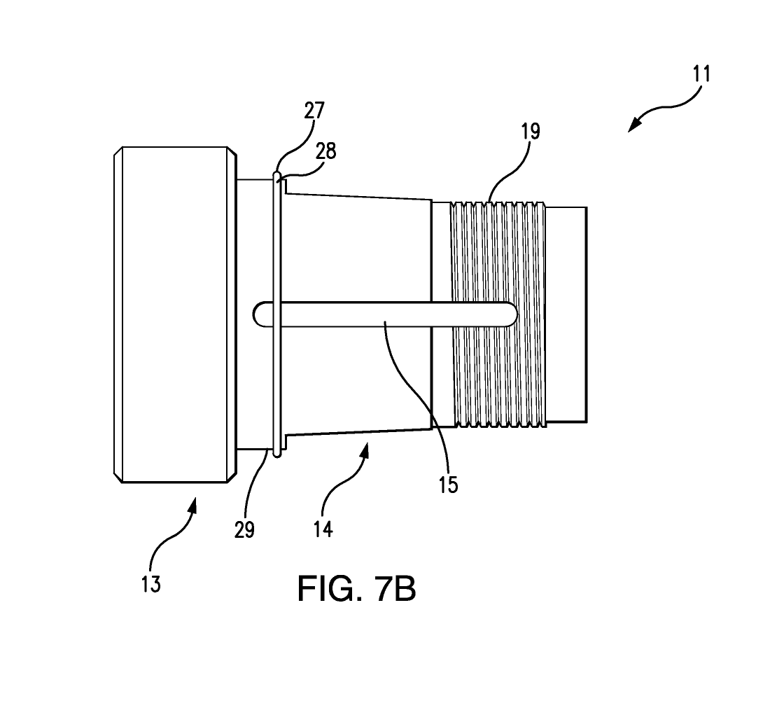

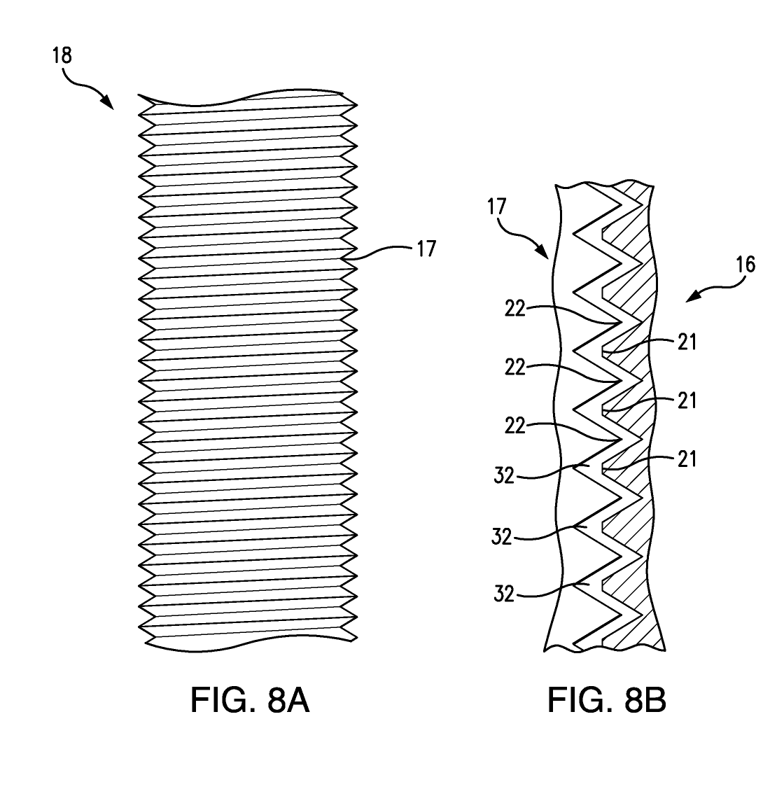

FIGS. 5B, 7B and 11B depict the second preferred embodiment of the present invention, in which a compressible O-ring 27 is provided in a first annular groove 28 located in an external untapered section 29 at the top of the bushing core shaft 14. A cooperating second annular groove 30 is provided in a corresponding congruous internal untapered section 31 at the top of the bushing sleeve 12. When the bushing sleeve 12 is being tightened on the bushing core 11, the internal untapered section of the bushing sleeve 31 initially engages the O-ring 27, causing it to contract within the first annular groove 28. When the bushing sleeve 12 is fully tightened, the second annular groove 30 of the bushing sleeve 12 becomes aligned with the first annular groove 28 of the bushing core 11, such that the O-ring 27 expands into the second annular groove 30 of the bushing sleeve 12, thereby locking the bushing sleeve 12 in place. Not only does this O-ring feature 27 prevent the bushing sleeve 12 from loosening, it also prevents the bushing sleeve 12 from being over-tightened so as to strip the conjugate threading between the bushing sleeve 12 and the bushing core 11.

Although the preferred embodiments of the present invention have been disclosed for illustrative purposes, those skilled in the art will appreciate that many additions, modifications and substitutions are possible, without departing from the scope and spirit of the present invention as defined by the accompanying claims.

What is claimed is:

1. A composite bushing for fixing the position of an adjustment screw, the bushing comprising:
a flexibly resilient, slotted bushing core, which is compressibly engaged by a cylindrical annular bushing sleeve;
wherein the bushing core further comprises a rigid annular head and a flexibly resilient tapered shaft, having tapered shaft diameters less than the diameter of the head, and wherein the shaft has a proximal section, which is adjacent to the head, a distal section and a mid-section, and wherein the tapered shaft diameters decrease from the proximal section to the distal section;
wherein the bushing core has an interior core axial bore, and wherein the entire length of the core axial bore has internal core threading, which is configured to engage conjugate external screw threading of the adjustment screw, so as to adjust the position of the adjustment screw;
wherein the bushing sleeve has a proximal side with a proximal end and a distal side with a distal end, and wherein the bushing sleeve has an interior sleeve axial bore, and wherein the sleeve axial bore has tapered bore diameters which decrease from the proximal side to the distal side and are slightly greater than corresponding tapered shaft diameters of the bushing core;
wherein the sleeve axial bore on the distal side of the bushing sleeve has internal sleeve threading, which is configured to engage conjugate exterior core threading on the distal section of the shaft of the bushing core;
wherein the shaft of the bushing core has multiple longitudinally-oriented oblong core slots, which originate from the proximal section of the shaft, pass through the mid-section of the shaft, and terminate in the distal section of the shaft, thereby defining a slot sector of the shaft; and
wherein progressive conjugate engagement of the internal sleeve threading with the exterior core threading causes the bushing sleeve to advance through multiple interthreading positions along the exterior of the shaft of the bushing core from the distal section to the proximal section until the bushing sleeve reaches a fully-tightened interthreading position, thereby causing the tapered shaft diameters to constrict, and thereby inducing a tight radial interthread engagement between the internal core threading and the external screw threading, so as to fix the position of the adjustment screw.

2. The composite bushing of claim 1, wherein internal core threading in the slot sector of the shaft comprises truncated V-threads, and wherein the external screw threading comprises sharp V-threads, and wherein, in the fully-tightened interthreading position of the bushing sleeve, the tight radial interthread engagement between the internal core threading and the external screw threading produces in the slot sector multiple circumferential interthread channels between the truncated V-threads and the sharp V-threads, and wherein a lubricant applied to the adjustment screw is thereby constrained to flow within the interthread channels and is blocked from migrating laterally along the adjustment screw beyond the slot sector of the shaft of the bushing core.

3. The composite bushing of claim 2, wherein, in the fully-tightened in interthreading position of the bushing sleeve, multiple circumferential intra-bushing channels are formed between the interior of the bushing sleeve and the exterior of the bushing core, and wherein the lubricant constrained within the interthread channels of the slot sector of the shaft of the bushing core, upon reaching a critical radial pressure, migrates through the core slots into the intra-bushing channels, thereby relieving the radial pressure of the lubricant, while retaining the lubricant within the composite bushing.

4. The composite bushing according to claim 3, wherein the distal end of the bushing sleeve has multiple keyway depressions, which are engaged cooperatively by multiple congruous key projections of a miniature crescent mini-wrench, and wherein the mini-wrench is used to apply an incremental torque to the bushing sleeve so as to advance the interthreading position of the bushing sleeve to the fully-tightened interthreading position, thereby tightening the interthread engagement between the internal core threading and the external screw threading.

5. The composite bushing according to any one of claims 1 through 4, wherein the proximal section of the shaft adjacent to the head of the core bushing has an untapered annular ledge which contains a first annular groove, and wherein the proximal end of the bushing sleeve has an untapered annular socket, which is configured to conjugately and fully engage the annular ledge, and wherein the annular socket contains a second annular groove that aligns with the first annular groove when the annular ledge and the annular socket are fully engaged, and wherein a compressible O-ring resides in the first annular groove, and wherein progressive conjugate engagement of the bushing sleeve with the bushing core and the annular ledge with the annular socket causes the O-ring to contract within the first annular groove until the bushing sleeve reaches the fully-tightened inthreading position, whereupon the O-ring expands into the aligned second annular groove, thereby locking the bushing sleeve in place.
